(19) United States
(12) Patent Application Publication
(10) Pub. No.: US 2022/0048630 A1
(43) Pub. Date: Feb. 17, 2022

(54) SEAT ASSEMBLY FOR AIRCRAFT

(71) Applicant: Airbus Operations S.L.U., GETAFE (ES)

(72) Inventors: Aida ALVAREZ RODRIGUEZ, GETAFE (ES); Raúl Carlos LLAMAS SANDIN, GETAFE (ES)

(21) Appl. No.: 17/399,404

(22) Filed: Aug. 11, 2021

(30) Foreign Application Priority Data
Aug. 13, 2020 (ES) U202031834

(51) Int. Cl. B64D 11/06

(52) U.S. Cl. CPC B64D 11/0636; B64D 11/0606

(57) ABSTRACT

A seat assembly for an aircraft cabin, wherein the seat assembly includes, in a same row a first seat, and a second seat, and a storage compartment disposed in an adjacent manner between the first and second seats. The storage compartment is sized to accommodate luggage of a passenger in either or both of the first and second seats.

### CROSS-REFERENCES TO RELATED APPLICATIONS

This application claims the benefit of the Spanish patent application No. U202031834 filed on Aug. 13, 2020, the entire disclosures of which are incorporated herein by way of reference.

### FIELD OF THE INVENTION

The present invention relates to a seat assembly for aircraft and, in particular, a seat assembly configured to limit the passenger capacity in an aircraft cabin. As shall be seen, reducing capacity may be of benefit to an airline.

Although the cabin of an airplane provides a high level of cleanliness, the invention permits enhancing the sensation of passenger health safety in terms of a situation of disease contagion between passengers. The present invention falls within the efforts of aircraft manufacturers to adapt the operating situation of airline companies to the new paradigm in passenger transport within the context of the emergent infectious diseases.

Additionally, and in any situation not necessarily related to a health context, the present invention allows the conversion of economy class seats into a higher class, permitting passengers to travel with more hand luggage and/or more personal space, and facilitating access to the luggage thereof during the flight.

The invention also proposes another economic model, wherein an airline transports more cargo (i.e., merchandise) and fewer passengers.

The seat assembly of the present invention is characterized by the fact of replacing the space which one seat would occupy by a storage compartment. By means of this there is provided, firstly, the physical separation of passengers during the journey, secondly, the provision of additional space for transporting cabin luggage and, thirdly, allowing airline companies to repurpose a part of the cargo holds for the transport of merchandise, paving the way to the possibility of alliances with cargo airlines.

According to one example of embodiment, this seat assembly furthermore provides means of physical separation, such as panels and windows, to increase the privacy of passengers during the flight.

### BACKGROUND OF THE INVENTION

The new infectious diseases have brought about a new social situation leading to an increase in, inter alia, safety standards in matters of public health, wherein physical distancing and the daily utilization of sanitizing material have acquired strength in terms of efficacious measures to prevent possible contagion.

These measures are not always aligned to the policies established by airline companies wherein exploiting the useful space of the airplane and fast boarding protocols have permitted optimization of costs and, thereby, reduction in prices, converting air transport into an attractive means for almost the entire population.

Proof of the success achieved has been the appearance of airline companies having policies of low prices and an increasingly greater offer of flights, frequencies and destinations.

Flowing therefrom there arises the requirement to provide for the population an easy and safe way of continuing to use public transport, reducing the sensation of the passengers of exposure to situations presenting some probability of contagion, not solely during the flight per se, but in all the stages wherein the passenger may feel exposed.

### SUMMARY OF THE INVENTION

A first inventive aspect provides a seat assembly for an aircraft, characterized in that the seat assembly comprises, in a same row:

a first seat and a second seat, and

a storage compartment disposed in an adjacent manner between the first and second seats.

Throughout the present document the term “seat assembly” shall be understood to be the block of linked seats disposed in a consecutive manner and orientated in the same direction having the objective of installation or removal as a body from the vehicle wherein they are housed. For example, in aviation, this seat assembly is customarily represented, in economy class, by three contiguous seats of standard type in order to reduce the problems of installation and, once installed, to take best advantage of the space.

In this manner, the present invention makes use of the space destined for the central seat in order to utilize it as a luggage storage zone. Consequently, the first and second seats, that is to say, the seats situated at the extremities, are destined to accommodate passengers who may place their luggage in the central storage compartment.

In the supposition that the seat assembly were to be disposed in an aircraft having a single aisle, in a situation of utilization of the seat assembly the first seat would be disposed proximate to the window, while the second seat would be disposed proximate to the central aisle. The inverse situation, wherein the positions of the first and second seats are interchanged in respect of the foregoing definition, is also possible and is considered to be equivalent throughout the entire description.

In this manner, by rendering the central seat inoperative, firstly the distancing of the passengers seated in the first and second seats is achieved. In this manner, the perception of confinement is reduced while physical distancing criteria are obeyed, minimizing possible risks of contagion.

Secondly, by rendering more storage space available within the vehicle, the passengers are permitted to look after their luggage at all times without a requirement for handling on the part of airport workers. This would reduce the possibility of contagion through contact.

If the seat assembly is situated in an aircraft. the density of passengers in check-in queues is, in addition, reduced, each passenger being permitted to carry the luggage thereof on board and paving the way to new forms of attributing costs for this service. This additionally responds to the growing demand from passengers to be able to carry the luggage thereof on board with them in order to board/disembark from the aircraft in a more rapid manner.

As the reduction in seats available brings therewith fewer sources of revenue for the airlines, the arrangement of the central seat as a storage zone may free up part of the cargo hold, paving the way to the possibility of alliances between passenger companies and cargo companies in order to obtain new business.

Throughout the present document the term “storage compartment” shall be understood as a space delimited by means of walls or other elements, appropriate for the storage of luggage, personal baggage, or other types of load. The term “luggage storage compartment” shall be understood to be equivalent.

In one preferred embodiment, the seats are economy class seats. Differing from business class, it disposing of more individual space per passenger in exchange for higher prices, economy class has greater density of seats in order to be able to offer a greater number of places and, by means thereof, to reduce prices.

Consequently, economy class passengers are, by defect, more proximate to one another and benefit more through the implementation of seat assemblies according to the present invention in passenger transport vehicles.

In one embodiment, the seat assembly comprises a support structure, the first seat and the second seat being affixed to the support structure, and the storage compartment being installed upon the structure.

That is to say, in this embodiment the seat assembly comprises:

a support structure configured to support at least three seats, preferably of economy class,

the first and the second seats installed upon the support structure, and

the at least one storage compartment installed upon the support structure.

The support structure forms a chassis whereupon the seats and/or the storage compartment are disposed and, furthermore, comprises the system of connection/disconnection of the seat assembly to the floor of the vehicle wherein it is housed. This system is normally standardized in order to permit the interoperability of various types of seat assemblies according to the preferences of the operator.

On the basis of this structure there are provided at least two examples of the seat assembly, either the storage space is disposed upon the central seat or the storage space replaces the central seat.

Consequently, in one embodiment, the at least one storage compartment is installed directly upon the support structure. This embodiment provides greater storage space.

In an alternative embodiment the seat assembly comprises an additional seat between the first and second seats such that the storage compartment is disposed upon the additional seat, supported upon the same. This embodiment permits rapid implementation by virtue of the fact that the storage compartment may be manufactured in a separately and installed in the present configurations.

It must be emphasized that, although the storage compartment may have available the space until now occupied by the central seat, in other embodiments, the space of each position may vary, for example, through increasing (or decreasing) the lateral seats and providing less (or more) storage space.

In any case, keeping the support structure permits benefiting from the standard connections customarily employed, in this manner limiting the number of modifications to be executed in the vehicles.

In one embodiment, the storage compartment comprises means of affixation in order to secure the seat assembly in a removable manner. In a preferred manner, the means of affixation are secured to bars of the support structure.

In one embodiment, the storage compartment is accessible either by the frontal part, the upper zone, or any of the sides thereof adjacent to a seat. It is simpler to access the storage compartment, in order to leave or remove the luggage stored, by the frontal or the upper part, however access by means of the sides brings therewith additional advantages by reducing inter passenger interaction for the purpose of reaching agreement regarding the order wherein they access the compartment.

In one embodiment, the storage compartment is accessible solely from the first seat or the second seat.

In one embodiment the storage compartment comprises means of retention configured to secure at least one suitcase within the interior thereof. Preferably, the means of securing comprise at least one lockable door, more preferably at least one lockable sliding door.

By lockable door there shall be understood a door presenting a mechanism ensuring the non-accidental opening thereof and supporting the loads required by the aircraft certification regulations. For example, this mechanism may be similar to that presently employed in cabin overhead lockers.

In one embodiment, the storage compartment is compartmentalized into two spaces, wherein each comprises a lockable door independent of the other. This reduces the interaction between the passengers in a same row and avoids contact between the respective luggage or personal belongings thereof.

Specifically, the storage compartment may be divided into an upper space and a lower space, each door being at the corresponding height thereof, or into two laterally adjacent spaces, the two doors being at the same height.

However, in an alternative embodiment, the storage compartment is compartmentalized into two spaces, both spaces sharing the same lockable door.

In one embodiment, the storage compartment is manufactured with reinforced plastic. Examples of reinforced plastic are a composite material containing glass fiber, carbon fiber or Kevlar.

In one embodiment, the storage compartment is configured to accommodate at least one suitcase, preferably of hand luggage type. In a preferable manner, the storage compartment is configured to accommodate at least one suitcase the height whereof is of up to 80 cm.

As is well known, the dimensions of hand luggage have been standardized in recent years as a consequence of the exemption thereof from being checked-in for many low cost airlines. Typical values are of 40-56 cm in height×30-45 cm in width×20-25 cm in depth.

However, by virtue of these compartments being capable of accommodating checked luggage having greater dimensions, i.e., exceeding 60 cm in height, freeing of the luggage hold for other uses is achieved.

It must be emphasized that, although a seat assembly having three spaces or positions has been defined, in some embodiments more spaces may be disposed of, either contiguous to the first seat or to the second seat, these spaces being either of at least one seat (i.e., realized in the form of a “third seat”), or of at least one storage compartment (i.e., realized as a “second storage compartment”).

Arising therefrom, in one embodiment one seat and one luggage storage space are alternated for any number of seats. This embodiment is especially beneficial for those vehicles permitting housing continuous rows having many seats, for example, twin aisle aircraft in the central column.

In addition to distancing passengers, the seat assembly according to the present invention is characterized by minimizing possible contact between the passengers seated each in the seats thereof and provides an individual and partially enclosed zone for each passenger, in order to reduce the probability of contagion through droplet dispersion or respiration.

Consequently, in one embodiment, the at least one storage compartment comprises a dividing screen in the upper part thereof. In this manner a physical separation is provided between passengers seated in the same seat assembly.

In one embodiment, the at least one economy class seat is disposed at one extremity of the seat assembly, for example to be situated at or proximate to an aisle or proximate to a window of the aircraft, the seat comprising a headrest and a lateral screen separating the seat at the height of the headrest from the aisle.

In this manner, not solely is contagion between passengers seated in the same seat assembly reduced but the exposure is reduced of the passenger seated adjacent to the aisle to the passing of other passengers of the vehicle.

In one embodiment, the seat assembly furthermore comprises a rear screen occupying at least one upper zone of at least one seat. This reduces the exposure of passengers to possible sneezes or to the coughing of the passenger seated in the immediately posterior row, that is to say, just behind. In this manner the prevention of possible airborne infection is achieved.

The disposition of screens, both at the sides and at the rear part of the passenger, would lead to a partial enclosure reducing the visibility in the cubicle formed. For this reason, in one embodiment, the rear screen furthermore comprises a frame having at least one light configured to illuminate substantially the zone of the seat. In a preferred embodiment the at least one light is directable. In one embodiment the screens are transparent in order to permit visibility and reduce the sensation of enclosure in the cubicle.

As another of the efficacious means to palliate the propagation of contagious diseases, in one embodiment, the seat assembly is configured to accommodate disposable sanitizing material. The disposable sanitizing material may comprise: toilet paper, and/or disinfectant gel (e.g., hydroalcoholic gel), and/or facemask (surgical type or a cloth facemask), and/or gloves of latex, vinyl, or nitrile.

In a preferred embodiment, the disposable sanitizing material is provided sterilized in the form of an individual personal kit within a sealed bag. That is to say, the seat assembly comprises that sealed bag containing the sanitizing material.

In one embodiment, the disposable sanitizing material is situated in a posterior pocket of the at least one of the seats in order to render it available to the passengers behind the seats. In an alternative embodiment, the disposable sanitizing material is situated adjacent to the storage compartment.

In a second inventive aspect, the invention provides an aircraft cabin characterized in that it comprises a seat assembly according to any of the embodiments of the first inventive aspect.

The cabin of an aircraft includes the pressurized zone of the fuselage wherein the passengers are housed. As has been stated, in this inventive aspect the vehicle is an aircraft having a single aisle or twin aisles.

Throughout the description it shall be understood that the cabin organizes the seats in rows and columns. Consequently, for example, an aircraft having a single aisle will have two columns, while a twin aisle aircraft will have three columns of seats. Each row is identified with a consecutive line of seats all at the same distance from the cockpit (for the flight crew). Consequently, two contiguous rows shall be understood to be one in front of the other.

In one embodiment, the cabin is of single aisle and presents, in the economy section thereof, at least three seats to one side of the aisle, characterized in that at least one of those groups of three seats is a seat assembly according to any of the embodiments of the first inventive aspect.

In another embodiment, the aircraft is of twin aisles forming three columns and presents, in the economy section thereof, at least three seats of economy class to one side of the aisle, characterized in that at least one of those groups of three seats is a seat assembly according to any of the embodiments of the first inventive aspect.

In one embodiment, the central column comprises at least 4 seats in at least one of the rows thereof, preferably in all rows thereof, that is to say, it comprises at least 4 seats per row.

In one embodiment at least two contiguous rows in the same column comprise the same number of seat assemblies according to any of the embodiments of the first inventive aspect. Contiguous is understood in the sense of the longitudinal direction of the cabin.

In one embodiment, in at least two contiguous rows of seat assemblies in the longitudinal direction of the cabin, the at least one luggage storage space of each seat assembly and the seat are disposed in an alternate manner, that is to say, in front of or behind an economy class seat there is situated at least one storage compartment.

In an alternative embodiment, in contiguous rows of seat assemblies in the longitudinal direction of the cabin, the at least one storage compartment of each seat assembly is in the same position, that is to say, in front of or behind a storage compartment there is situated the storage compartment of the corresponding seat assembly thereof.

In one embodiment, for example where the central column is wide and permits housing many seats, the seat assembly may comprise two additional contiguous storage compartments, either separated one from another or forming a single storage compartment of greater dimensions than if they were separate.

In one embodiment, wherein the central column comprises 5 seats per row, the cabin is characterized in that the outermost and central positions are seats and the intermediate positions are implemented as the same number of storage compartments.

That is to say, numbering the seats of that row, the first, third and fifth positions would correspond to seats, whilst the second and the fourth would be implemented in the form of storage compartments.

In a third inventive aspect, the invention provides an aircraft characterized in that it comprises an aircraft cabin according to any of the embodiments of the second inventive aspect.

In one embodiment, the aircraft is of the passenger transport type and is characterized in that part of the cargo hold is adapted for the transport of merchandise.

As has been stated, this permits alliances between companies to take advantage of the new space available. Depending on the frequency of visits of each aircraft to the same destination, the aircraft may be adapted to conserve the types of product imported/exported therefrom.

Other examples of embodiment shall be described below, assisted by figures.

All the characteristics and/or the stages of methods described in this memorandum (including the claims, description and drawings) may be combined in any combination, excepting the mutually exclusive combinations of such characteristics.

### BRIEF DESCRIPTION OF THE DRAWINGS

These and other characteristics and advantages of the invention shall be set out more clearly on the basis of the following detailed description of a preferred manner of embodiment, provided solely on the basis of an illustrative and non-limitative example making reference to the accompanying figures.

FIG. 1 shows an example of an embodiment of a support structure for the seat assembly according to the invention.

FIG. 2 shows an example of embodiment of a seat assembly according to the invention.

FIG. 3a shows an example of embodiment of an aircraft cabin in economy class configuration according to the invention.

FIG. 3b shows a cross-sectional view of the cabin of FIG. 3a in order to illustrate the disposition of the passenger seated in a seat assembly according to the present invention, together with the luggage thereof.

### DETAILED DESCRIPTION OF THE PREFERRED EMBODIMENTS

A person skilled in the art will be capable of identifying that the aspects and details herein described are realizable in the form of a seat assembly (1), of an aircraft cabin (10), or of an aircraft as such.

The present invention, according to the first inventive aspect, is a seat assembly (1) for an aircraft, characterized in that the seat assembly comprises, in a same row:

a first seat (2), and a second seat (3), and

a storage compartment (4) disposed in an adjacent manner between the first (2) and second (3) seats.

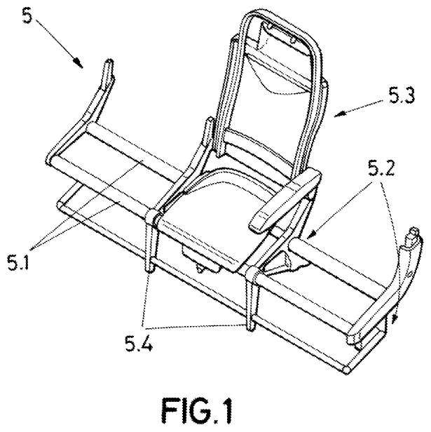

FIG. 1 shows a support structure (5) for the seat assembly (1) according to the invention. In particular, there may be appreciated a chassis formed by bars (5.2) and tubes (5.1) conferring rigidity upon the structure. For example, it may be observed that the structure is formed by two tubes (5.1) disposed longitudinally at the height of the seat (5.3) and several transverse bars (5.2) to confer rigidity.

There may also be observed the support legs (5.4) upon the floor of the cabin and the seat skeleton (5.3) lacking the padded zone. There exists a basic structure supporting and maintaining in position a seat platform and a back extending until forming the headrest. For illustrative reasons, solely one seat skeleton is shown in the central position, however it could equally be in the outermost positions.

In addition, although not shown, this structure (5) comprises a mechanism of connection/disconnection, normally of standard type, permitting the installation and deinstallation thereof in the cabin (10).

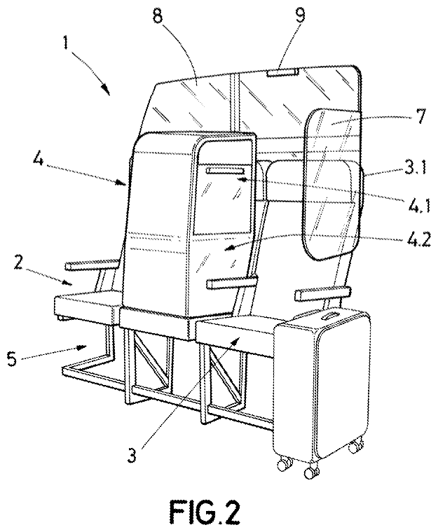

FIG. 2 shows an example of an embodiment of a seat assembly (1) according to the invention. The seat assembly (1) comprises:

a support structure (5) configured to support at least three economy class seats,

the first (2) and the second (3) seats installed upon the support structure (5), and

a storage compartment (4) installed upon the support structure.

As may be appreciated, the storage compartment (4) has been installed in the intermediate space provided for an additional economy class seat, specifically it is implemented upon the additional central seat, being supported upon the same. Consequently, the storage compartment disposes of the same space previously available to the passenger seated in that seat.

As has already been stated, this central seat or support may be narrowed or widened to change the space available for the compartment, transferring it to or removing it from any of the lateral seats (or to/from both thereof at the same time), according to policies of the company. In this manner, more spacious seats may be offered including an on board personal locker, for example.

The compartment (4) shown is compartmentalized into two spaces, one lower (4.2) and another upper (4.1), each thereof presenting a lockable sliding door independent of the other. In this manner, the right-hand seat disposes of the upper part and the left-hand seat of the lower part. Although not observable in the figure, each of the doors is slidable in a vertical sense, that is to say, in a downwards direction. However, it is observable in the side visible from that perspective how the sliding door is displaced slightly downwards, in addition to the handle permitting the operation of the door by the passenger being observed.

Furthermore, the spaces are compartmentalized by means of a shelf whereupon the upper luggage may be supported. Similarly, compartmentations may be offered in the vertical sense, separating the spaces in terms of “left and right” or “front and rear”.

A checked suitcase is also shown at the foot of the seat assembly for the purposes of picturing the dimensions of the compartment. This suitcase shown has a height of 60 cm and could be accommodated in the compartment (4), for example in the lower space (4.2).

Preferably, the compartment (4) has a shape substantially that of a rectangular prism of dimensions of at least 43×40×60 cm (width between seats, depth of seat, height).

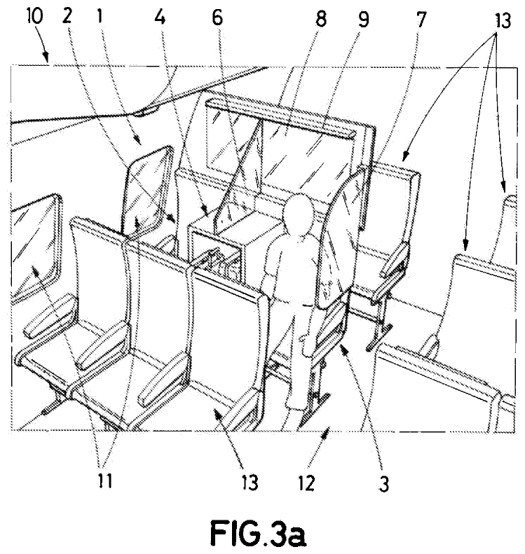

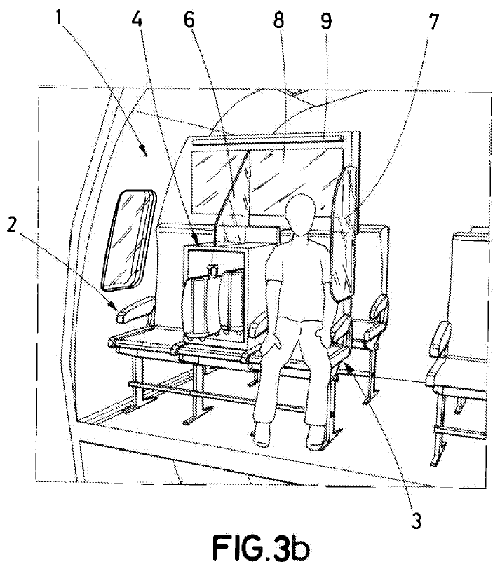

In addition, in this embodiment the seat assembly (1) comprises means to prevent the airborne propagation of diseases. In this manner, the compartment (4) comprises a dividing panel (6) in the upper part thereof to physically separate the passengers seated in the same seat assembly (1). Although not shown in FIG. 2 for illustrative reasons, this dividing panel (6) is shown in FIGS. 3a and 3b.

As may be observed, in this embodiment the economy class seat (3) planned to be situated proximate to the aisle (12) in the aircraft cabin, additionally comprises a side screen (7) separating the seat (3) at the height of the headrest thereof (3.1) from the aisle (12). A third screen (8) occupies at least an upper zone of the economy class seats (2, 3). In this figure, the rear screen (8) occupies the entirety of the rear part of the seat assembly (1), however it could be divided into two or more parts, one for each seat (2, 3).

The screens are preferably manufactured from a transparent plastic material having properties compatible with the requirements of aircraft certification such as, for example, polycarbonate or polymethylmethacrylate.

The first seat (2), in turn, is situated proximate to a window (11) of the cabin (10).

In order to illuminate the cubicle formed by the set of screens (6, 7, 8) the rear screen (8) furthermore comprises a frame having at least one light (9) configured to illuminate substantially the zone of the seat (2, 3). The light may be fixed or directable, or both may coexist.

Through incorporating all the elements thereof into the seat assembly (1) itself, it is understood that the invention is readily implementable in the present models of cabin (10).

Apart from the physical distancing measures, the seat assembly is configured to accommodate disposable sanitizing material such as, for example, toilet paper, and/or hydroalcoholic gel, and/or facemask (such as of surgical type or a cloth facemask), and/or gloves of latex, vinyl, or nitrile. This sanitizing material may be provided sterilized in the form of an individual personal kit within a sealed bag.

This bag may be distributed or replaced by the cabin crew prior to each flight by means of refilling a pocket of the seat assembly (1) capable of holding it.

Although not observed for illustrative reasons, the luggage storage compartment (4) may also comprise a label bearing explanations and directions of a hygiene nature. This label may contain the hygiene regulations of the company operating the aircraft in respect of the use of the sanitizing material being provided and/or practices recommended by national or international health authorities, such as the World Health Organization.

Below, there shall be described an aircraft cabin (10) in economy class configuration, as may be appreciated in FIGS. 3a and 3b. The cabin (10) comprises at least one seat assembly (1) according to that described in relation to FIG. 2.

A person skilled in the art will understand that the seat assembly (1) is not exclusive, but preferred, to the aeronautical environment, and could equally be applied to any other cabin of vehicles using this type of seat assemblies.

Returning to FIG. 3a, the cabin shown represents a portion of an economy class of a single aisle aircraft. Consequently, in the part shown the seats are organized into two columns each thereof having three rows, although the cabin may have more rows.

By having illustrated solely one seat assembly (1) according to the present invention in relation to the 6 shown (1, 13), the dimensions thereof may be compared to the customary standard (13). Consequently, it is observed that the compartment of the seat assembly (1) disposes of the same space as the central seat of any of the other standard seat assemblies (13).

Should the use of the seat assembly (1) according to the invention be extended to the contiguous rows, the luggage storage space (4) could:

either be disposed in an alternate manner in each row, that is to say, in front of or behind an economy class seat (2, 3) there may be situated a luggage storage space (4), or

be disposed in the same position, that is to say, in front of or behind a luggage storage space (4) there may be situated the luggage storage space (4) of the corresponding seat assembly thereof.

Equally, these configurations may be combined in a given cabin (10) in order to ensure the uniform distribution of weight or even to group/disperse passengers on the same fare within the cabin.

FIG. 3b permits visualizing the cubicle formed by the panels (6, 7, 8) and the useful space per passenger. It can be confirmed that the passenger is protected from those seated behind or alongside the same in the same seat assembly (1).

In FIGS. 3a and 3b one of the walls of the compartment (4) has been suppressed in order to visualize the internal space and verify the ability thereof to accommodate one or more items of hand luggage. Consequently, as previously stated, the passenger is enabled to carry on board therewith, and look after at all times during the flight, the luggage thereof, offering the tranquility of it not being touched by third parties. In addition, this avoids crowds at the points of luggage check-in and reclaim and permits boarding and disembarking from the aircraft more rapidly.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A seat assembly for an aircraft cabin, wherein the seat assembly comprises, in a same row:
a first seat, and a second seat, and
a storage compartment disposed in an adjacent manner between said first and second seats.

2. A seat assembly as claimed in claim 1, wherein the seat assembly comprises a support structure, the first and the second seat being affixed to the support structure, and the storage compartment being installed upon the support structure.

3. A seat assembly as claimed in claim 2, wherein the storage compartment is installed directly upon the support structure.

4. A seat assembly as claimed in claim 1, wherein the seat assembly comprises an additional seat between the first and the second seat, and wherein the storage compartment is disposed upon said additional seat, supported upon the same.

5. A seat assembly as claimed in claim 1, wherein there is alternated a seat and a storage compartment for any number of seats.

6. A seat assembly as claimed in claim 1, wherein the storage compartment comprises a dividing screen in an upper part thereof.

7. A seat assembly as claimed in claim 1, wherein at least one of the first seat or the second seat is disposed at an extremity of the seat assembly and comprises a headrest and a side screen disposed at a height of the headrest.

8. A seat assembly as claimed in claim 1, wherein the storage compartment comprises means of affixation to be secured in a removable manner upon the seat assembly.

9. A seat assembly as claimed in the claim 2, wherein said first and second seats are secured to bars of the support structure.

10. A seat assembly as claimed in claim 1, wherein the storage compartment comprises means of retention configured to secure at least one item of hand luggage within an interior thereof.

11. A seat assembly as claimed in claim 10, wherein said means of retention comprise at least one lockable door.

12. A seat assembly as claimed in claim 11, wherein the storage compartment is compartmentalized into two spaces, wherein each space comprises a lockable door independent of the other lockable door.

13. A seat assembly as claimed in claim 11, wherein the storage compartment is compartmentalized into two spaces, wherein both spaces share a same lockable door.

14. A seat assembly as claimed in claim 1, wherein the storage compartment is accessible solely from the first seat or the second seat.

15. An aircraft cabin comprising a seat assembly as claimed in claim 1.

16. An aircraft cabin as claimed in claim 15, wherein the cabin is of a single aisle and is provided, in an economy section thereof, with at least three seats at one side of the aisle, wherein at least one group of three seats comprises the seat assembly.

17. An aircraft cabin as claimed in claim 15, wherein the cabin is of twin aisle forming three columns of seats and is provided, in an economy section thereof, with at least three seats at one side of the aisle, wherein the at least one group of three seats comprises the seat assembly.

18. An aircraft cabin as claimed in claim 16, wherein in at least two continuous rows of the same column in a longitudinal direction of the cabin, at least two groups of three seats comprise the seat assemblies.

19. An aircraft comprising an aircraft cabin as claimed in claim 15.

20. An aircraft as claimed in claim 19, wherein the aircraft is of passenger transport type, and wherein at least part of a cargo hold is configured for transport of merchandise.
